(19) United States
(12) Patent Application Publication
(10) Pub. No.: US 2004/0034557 A1
(43) Pub. Date: Feb. 19, 2004

(54) Unique business model using distributed personnel network methodology

(76) Inventor: Rao S. Anumolu, Smithtown, NY (US)

Correspondence Address: Rao S. Anumolu, ASR International Corp., 315 Oser Ave., Hauppauge, NY, 11788, US

(21) Appl. No.: 10/218,490

(22) Filed: Aug. 15, 2002

(51) Int. Cl. G06F 17/60; H04K 1/00

(52) U.S. Cl. 705/9; 705/51

(57) ABSTRACT

A business model to support requirements for Engineering and Technical personnel to perform tasks at any geographic location in the world, without requiring extensive travel. This is accomplished by having a network of Engineering Support personnel who live at geographically dispersed home bases, can travel to work sites within a commuting radius of their homes, and can rapidly respond to task assignments.

This invention relates to my unique business process and its associated computer support system. This process uses geographically dispersed Engineering Support personnel to perform task assignments as required at geographically dispersed sites near each persons home base. This replaces the current process of having several Engineering Support personnel traveling to the various task assignments in a sequential manner, which forces the task to be scheduled and performed in accordance with the persons travel schedule.

I am involved with the provisioning of worldwide Engineering support services in the fields of Quality Assurance, Technical Engineering, Information Technology, Management and Administrative support to government agencies and all Industries.

My new business process is based on using a large network of full/part time employees to perform work assignments throughout the world. This allows me to rapidly, (within 24/48 hours) support customer needs for many different types of Tehnical and Engineering support, audits, analysis, testing and studies, in any geographic location throughout the world. I use the best tools in automation, using e-mail, telephone, FAX, to maintain rapid information transfer.

The current process to support customer requirements starts with receiving a customer request to perform a technical audit or surveillance of one of their “out of town” suppliers. One of my technical experts is then alerted to the request and arrangements for the audit are started. Travel arrangements are made, starting with scheduling the audit with the supplier, obtaining airline tickets, hotel reservations, cash advance, transportation to the airport and return. My employee must disturb his normal work and also be paid for travel time.

My business process is based on replacing this small number of customer engineering and technical professionals who support field activities throughout the world by traveling from one job site to another, with a large number of my engineering and technical professionals whose homes are distributed throughout the world and therefore close to the scattered work sites. This reduces the need for extensive travel. The database of professionals is constantly replenished by an ongoing recruiting process. If the normal process is applied, the small number of professionals must travel from site to site by air, and auto, spending days traveling without accomplishing useful work. This is opposed to my process which eliminates the requirement for air travel and minimizes auto travel for local people. There is no airline ticket, hotel reservation, cash advance, transportation to the airport or disturbing normal company work, this improves the efficiency of completing work assignments.

[image]

My business strategy fulfills two requirements. It rapidly provides skilled personnel to satisfy customer needs, and it reduces travel costs to maintain total low cost solutions.

My business process is supported with a computer system (JARS) that keeps track of all personnel, by many different elements, such as skill specialty, geographic location, years of experience, education, special training and certification. This process allows me to analyze specific customer requirements, enter this need into the computer database and search for the best match to satisfy the requirements.

Specific information about each professional candidate is entered into the database. This includes the usual name, address, phone number, e-mail, FAX information. In addition I list many items such as employment skill, years of experience, employment history, education level, technical certifications, etc. The customer request for support will also list some specific requirements. These requirements are converted into “Keywords” to allow the computer to search its base to find as many matches as possible.

I can match geographic location requirements by searching for local Zip codes. The search area can then be expanded by adding Zip codes of surrounding areas. A second search criterion can then be added for skill requirement, such as QA inspector of boilers, or computer programmer with knowledge of C++. This search can keep narrowing to add some minimum number of years of experience, or any other specific requirement as needed.

The business process then advances to review of the computer selected candidates, choosing one to perform the immediate task. An e-mail is automatically generated to verify candidate availability and resume submittal to our customer if candidate is available. Customer acceptance of candidate is entered into the computer which then generates an e-mail notifying the candidate of any required interview.

The JARS program has a client/server LAN containing a large personnel database, currently over 28,000. The back end database runs on a powerful Sun Ultra server supplying requested information via Sun Workstations operating under Windows NT.

Entire electronic resumes can be entered into the computer file and separated into various categories such as Quality Assurance, Electrical, etc.; hard copy format would have to be electronically scanned into the files. When a candidate is selected for review, the resume can then be extracted, and sent to our customer for approval.

The program candidate files are periodically reviewed, updated and purged of obsolete information, in order to keep computer search time to a minimum.

I believe that my unique business process of using geographically distributed technical personnel, plus my JARS computer system to file, retrieve, and monitor the process is qualified and patentable.

What is claimed is:

1. A Business Model to provide full time and part time Engineering and Technical (E/T) personnel at any worldwide location

2. A Business Model to rapidly supply Quality Assurance, Technical Engineering, Information Technology, Management and Administrative Support personnel at the needed location.

3. A computerized Data Base that contains personnel records of all (E/T) personnel in the system.

4. A computer program which allows rapid search of the data base to select appropriate personnel with customer requested skill levels, experience, and geographic location for specific task assignments.

5. The computer program in item 4 will search for personnel in a defined geographic area, such as a ZIP code, and then can expand from that central point to include surrounding areas, until a match is found for qualified (E/T)s.

6. A computer program to automatically generate an electronic communication to determine availability and “desire to work”, of any selected person.
